(19) United States
(12) Patent Application Publication
(10) Pub. No.: US 2014/0133483 A1
(43) Pub. Date: May 15, 2014

(54) Distributed Switch Architecture Using Permutation Switching

(71) Applicant: BROADCOM CORPORATION, Irvine, CA (US)

(72) Inventors: Brad Matthews, San Jose, CA (US); Bruce Kwan, Sunnyvale, CA (US); Puneet Agarwal, Cupertino, CA (US)

(73) Assignee: BROADCOM CORPORATION, Irvine, CA (US)

(21) Appl. No.: 13/720,973

(22) Filed: Dec. 19, 2012

Related U.S. Application Data
(60) Provisional application No. 61/726,248, filed on Nov. 14, 2012.

(51) Int. Cl. H04L 12/56

(52) U.S. Cl. CPC H04L 49/101; H04L 47/25
USPC 370/360; 370/357

(57) ABSTRACT

A distributed switch architecture using permutation switching. In one embodiment, the distributed switch architecture facilitates connections between a plurality of ingress nodes and a plurality of egress nodes, wherein each of the plurality of ingress nodes and plurality of egress nodes are coupled to a plurality of ports (e.g., 40 gigabit Ethernet (GbE), 100 GbE, etc.). A plurality of crossbar switch modules are provided that are configured for coupling to a single output from each of the plurality of ingress nodes, and for coupling to a single input from each of the plurality of egress nodes. Permutations of connections for a crossbar switch module are defined by a permutation connection set that is stored in a permutation engine. Each permutation connection in the permutation connection can be designed to couple one of the outputs from the plurality of ingress nodes to one of the inputs from the plurality of ingress nodes, wherein the permutation connection set can ensures that each of the plurality of ingress nodes has an opportunity to connect with each of the plurality of egress nodes.

This application claims priority to provisional application No. 61/726,248, filed Nov. 14, 2012, which is incorporated by reference herein, in its entirety, for all purposes.

### BACKGROUND

1. Field of the Invention

The present invention relates generally to network switches and, more particularly, to a distributed switch architecture using permutation switching.

2. Introduction

Increasing demands are being placed upon the data communications infrastructure. These increasing demands are driven by various factors, including the increasing bandwidth and latency requirements. For example, while 10 Gigabit Ethernet (GbE) ports are commonly used for I/O on many of today's network switches, 40 GbE and 100 GbE ports are also anticipated to be commonplace in the near future. A key issue looking forward is the scalability of switch architectures to meet the ever-increasing bandwidth and latency needs.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of a distributed switch architecture using permutation switching.

FIG. 2 illustrates an example of permutation connections in a crossbar switch module.

FIG. 3 illustrates a flowchart of a process of the present invention.

FIG. 4 illustrates an example of buffer credit-based signaling.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

A scalable switch architecture is provided to meet the challenges presented by increasing bandwidth and latency requirements in a switch. In accordance with the present invention, a distributed switch architecture using permutation switching is provided. In one embodiment, the distributed switch architecture facilitates connections between a plurality of ingress nodes and a plurality of egress nodes, wherein each of the plurality of ingress nodes and plurality of egress nodes are coupled to a plurality of ports (e.g., 40 gigabit Ethernet (GbE), 100 GbE, etc.). A plurality of crossbar switch modules are provided that are configured for coupling to a single output from each of the plurality of ingress nodes, and for coupling to a single input from each of the plurality of egress nodes. Permutations of connections for a crossbar switch module are defined by a permutation connection set that is stored in a permutation engine. Each permutation connection in the permutation connection can be designed to couple one of the outputs from the plurality of ingress nodes to one of the inputs from the plurality of ingress nodes, wherein the permutation connection set ensures that each of the plurality of ingress nodes has an opportunity to connect with each of the plurality of egress nodes. In operation, the permutation engine is operative to sequentially reconfigure each of the plurality of crossbar switch modules based on a sequence of permutation connections as defined by permutation connection set.

In one embodiment, a sequence of operation can be defined such that a first predefined permutation connection is selected from a permutation connection set having a plurality of predefined permutation connections. The selected first predefined permutation connection is then used to configure, during a first clock cycle, a crossbar switch module in accordance with the selected first permutation connection. Here, the selected first permutation connection defines a set of cross connections between the plurality of ingress nodes and the plurality of egress nodes that are coupled to a crossbar switch module. A second predefined permutation connection is then selected from the permutation connection set. The selected second predefined permutation connection is then used to reconfigure, during a second clock cycle, the crossbar switch module in accordance with the selected second permutation connection. As the crossbar switch module progresses through the entire series of permutation connections in the permutation connection set, connections between the various plurality of ingress nodes and the plurality of ingress nodes can be facilitated with a measure of fairness. In one embodiment, the various connections can be equally weighted to assure fairness. In another embodiment, the various connections can be unequally weighted to facilitate uneven traffic conditions.

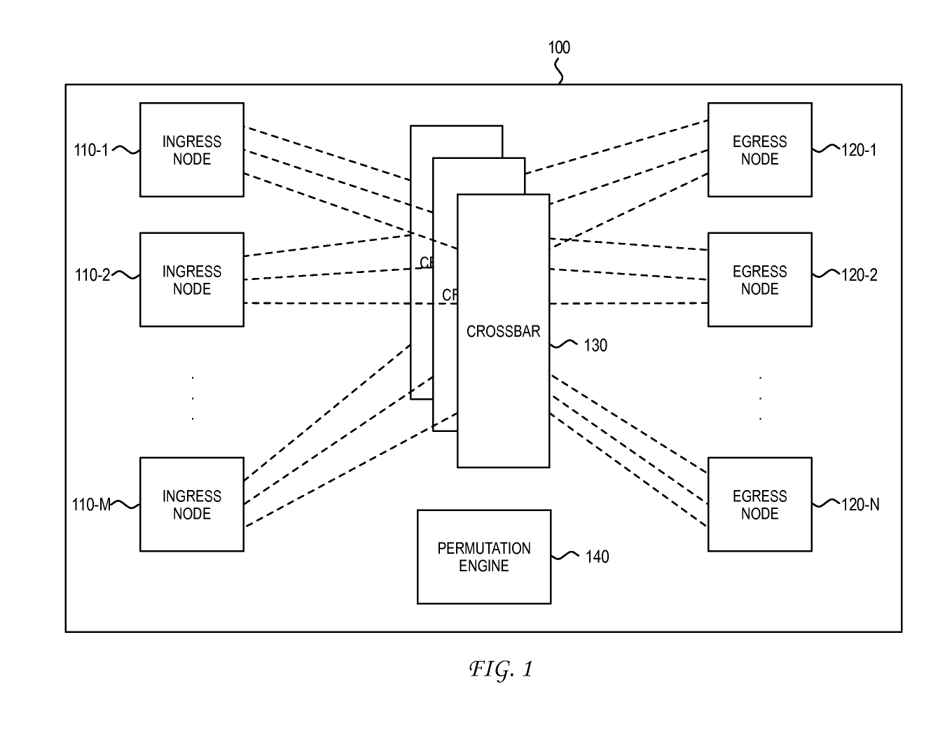

FIG. 1 illustrates an example embodiment of a distributed switch architecture using permutation switching. As illustrated, switch 100 includes a plurality of ingress nodes 110-m, each of which can be coupled to other network devices via a plurality of ports (e.g., 40 GbE, 100 GbE, etc.). As an example, each of ingress nodes 110-m can be designed to support 20×40 GbE ports or 8×100 GbE ports in facilitating connectivity to other switches in a data center. Similarly, switch 100 includes a plurality of egress nodes 120-n, each of which can be coupled to other network devices via a plurality of ports (e.g., 40 GbE, 100 GbE, etc.). As would be appreciated, the particular number and type of ports to which an ingress node 110-m or egress node 120-n is connected would be implementation dependent and would not limit the scope of the present invention. In various embodiments, each node can be embodied as a single die in a chip, multiple chips in a device, or multiple devices in a system/chassis. As would be appreciated, an ingress node and an egress node can be included on a single tile in a switch. It should also be noted that FIG. 1 illustrates an unfolded view of a switch. In a switch implementation, ports connected to an ingress node are the same as ports connected to an egress node. Received packets are processed exclusively by the ingress node to learn the set of destinations to which a packet would depart, and packets would be transferred to the egress node for additional packet processing and eventual transmission.

As illustrated, ingress nodes 110-m and egress nodes 120-n are each coupled to a plurality of crossbar switch modules 130. For example, ingress node 110-1 has a first output that is coupled to a first crossbar switch module, a second output that is coupled to a second crossbar switch module, and a third output that is coupled to a third crossbar switch module. Similarly, ingress node 110-2 has a first output that is coupled to the first crossbar switch module, a second output that is coupled to the second crossbar switch module, and a third output that is coupled to the third crossbar switch module, and ingress node 110-M has a first output that is coupled to the first crossbar switch module, a second output that is coupled to the second crossbar switch module, and a third output that is coupled to the third crossbar switch module.

As further illustrated, egress node 120-1 has a first input that is coupled to the first crossbar switch module, a second input that is coupled to the second crossbar switch module, and a third input that is coupled to the third crossbar switch module, egress node 120-2 has a first input that is coupled to the first crossbar switch module, a second input that is coupled to the second crossbar switch module, and a third input that is coupled to the third crossbar switch module, and egress node 120-N has a first input that is coupled to the first crossbar switch module, a second input that is coupled to the second crossbar switch module, and a third input that is coupled to the third crossbar switch module. As would be appreciated, the plurality of crossbar switch modules can each be coupled to a plurality of ingress nodes 110-m and a plurality of egress nodes 110-n. The specific set of connections to the crossbar switch modules would be implementation dependent.

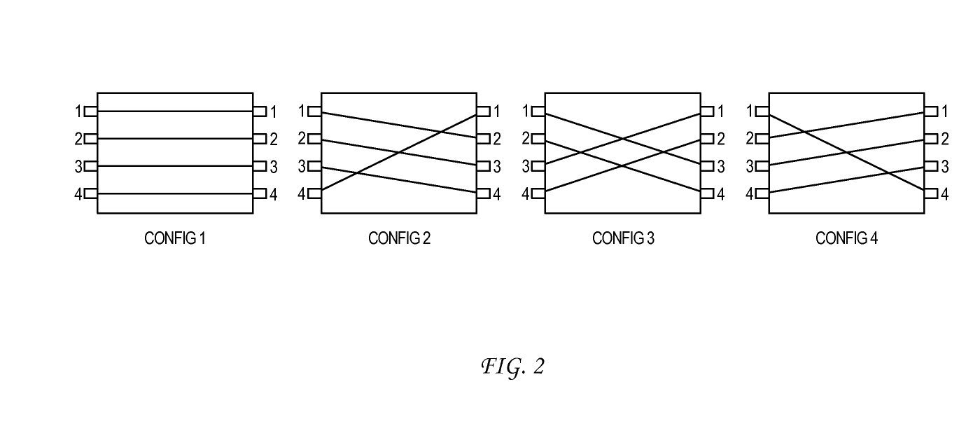

For a particular crossbar switch module that is coupled to a plurality of ingress nodes 110-m and a plurality of egress nodes 110-n, a plurality of permutation connections can be defined. In total, the plurality of permutation connections define a permutation connection set. Here, each permutation connection represents the crossbar switch module configuration for one or more clock cycles. To illustrate the various permutation connections that can exist within a permutation connection set, consider the example of FIG. 2, which illustrates the permutation connections in a crossbar switch module that is coupled to four ingress nodes and four egress nodes.

For this example, four permutation connections are defined in a permutation connection set. Specifically, a first permutation connection defines the connections for configuration 1, wherein input 1 is connected to output 1, input 2 is connected to output 2, input 3 is connected to output 3, and input 4 is connected to output 4, a second permutation connection defines the connections for configuration 2, wherein input 1 is connected to output 2, input 2 is connected to output 3, input 3 is connected to output 4, and input 4 is connected to output 1, a third permutation connection defines the connections for configuration 3, wherein input 1 is connected to output 3, input 2 is connected to output 4, input 3 is connected to output 1, and input 4 is connected to output 2, and a fourth permutation connection defines the connections for configuration 4, wherein input 1 is connected to output 4, input 2 is connected to output 1, input 3 is connected to output 2, and input 4 is connected to output 3.

In total, the four permutation connections in the permutation connection set define a set of connections that assure that each input is given an opportunity to connect to each output. For example, input 1 is sequentially connected to output 1, output 2, output 3, and output 4 in configuration 1, configuration 2, configuration 3, and configuration 4, respectively. Here, it should be noted that a crossbar switch module may be coupled to all of the output (or input) nodes in a switch or to only a subset of the output (or input) nodes in a switch.

The example of FIG. 2 illustrates an equal weighting scenario such that each input node has an equal opportunity to communicate with each output node. This equal weighting provides a measure of fairness. In other examples, a permutation connection set can be defined such that the set of connections produce an unequal weighting of connections. This can be useful, for instance, to address uneven traffic conditions. In a simple example, a permutation connection set can include two permutation connections that produce configuration 1, two permutation connections that produce configuration 2, two permutation connections that produce configuration 3, and one permutation connection that produces configuration 4. This would produce an imbalance in the connections between the inputs and the outputs as the permutation connections are cycled through. In general, any permutation connection set that defines an unequal number of connections between input nodes and output nodes can be used. This biasing of the permutation connection set can be used to address the state of the input nodes. For example, permutation connections can be skipped depending on the status of the input node (e.g., whether or not data is present) to save power, reduce latency, etc.

The permutation connection set is stored within or otherwise made accessible to permutation engine 140. During operation, permutation engine 140 can be configured to control the connections of each particular crossbar switch module to change in accordance with the plurality of permutation connections in a corresponding permutation connection set. Here, permutation engine 140 iterates through all permutation connections in the permutation connection set in S clock cycles. In one example, S represents the size of the permutation connection set. In general a permutation connection can be maintained for one or more clock cycles. Various advantages of using permutation connection sets include an absence of centralized arbitration, unneeded awareness of the state of ingress nodes and egress nodes, and low complexity/high speed.

In general, a crossbar switch module can be sized such that an input node can keep an output port busy while the permutation engine is forming other connections. Here, an operating rate of the crossbar switch module can be represented by the operating rate of the highest speed port divided by the width of the crossbar divided by the number of input nodes.

In one embodiment, a plurality of permutation connection sets are stored within or otherwise made accessible to permutation engine 140 to control the connections for a particular crossbar switch module. In one scenario, a first permutation connection set can be used for normal traffic conditions to produce fairness, while a second permutation connection set can be used for a unique traffic conditions where traffic on one or more ports is higher or lower than normal. In one embodiment, permutation engine 140 can be designed to dynamically adjust a permutation connection set to adapt to changing traffic conditions.

It is a feature of the present invention that the configuration of the multiple crossbar switch modules can be performed in parallel based on stored permutation connection sets. As such, the configuration of the crossbar switch modules is not reliant on a centralized matching algorithm that is configured to run matching algorithms to configure crossbar switch module connections. Such matching algorithms are limited in their ability to scale as matching constraints can limit the peak bandwidth of the switch (i.e., below the line rate).

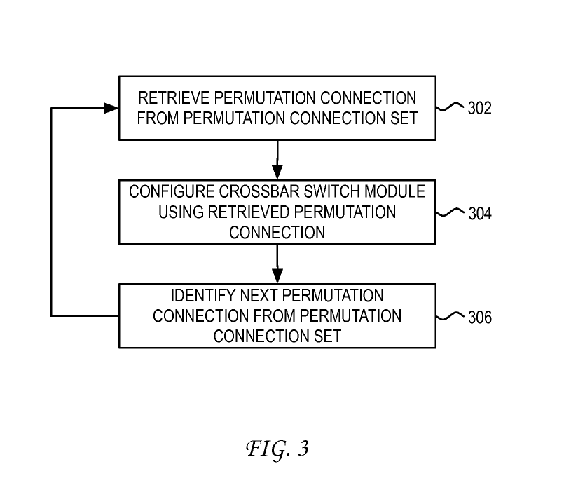

Having described a distributed switch architecture using permutation switching, the general principles of the present invention are now described with reference to the example flow chart of FIG. 3. As illustrated, the process of FIG. 3 begins at step 302 where a permutation connection in a permutation connection set is retrieved by a permutation engine. As noted, the permutation connection defines a particular configuration of connections in a crossbar switch module during a first clock cycle. The selection of the permutation connection is part of an iterative process in cycling through a permutation connection set and need not be based on the state of the ingress or egress nodes.

At step 304, the crossbar switch module is configured during a first clock cycle using the retrieved permutation connection. The next permutation connection in the sequence of permutation connections defined by the permutation connection set is then identified at step 306. Once identified, the process would continue back to step 302 where the identified permutation connection is retrieved. The crossbar switch module can then be reconfigured using the retrieved permutation connection in a second clock cycle. As illustrated in the example of FIG. 2, the process would continue to cycle through the set of permutation connections to ensure that the range of configurations provided connectivity between the plurality of ingress nodes and the plurality of egress nodes.

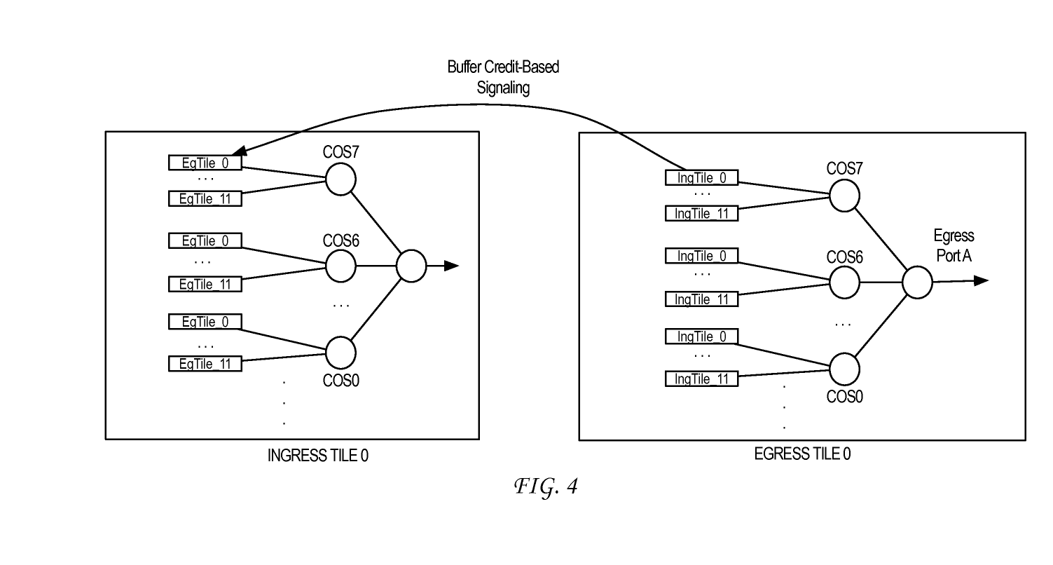

In one embodiment, management of congestion for single enqueue traffic (e.g., unicast) can be enabled through the use of shallow egress buffers. Here, credit-based signaling such as that illustrated in FIG. 4 can be used to “pull” packets from an ingress tile to an egress tile to ensure that drops do not occur at egress. For multi-enqueue traffic (e.g., multicast, mirror, loopback, etc.), management of congestion can be enabled through the use of small shared buffers. Multi-enqueue traffic can be pushed to egress with node-level flow control for that traffic type. In one embodiment, multi-enqueue traffic can be handled using an additional crossbar switch module.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A switch, comprising:
a plurality of ingress nodes, each of said plurality of ingress nodes having a plurality of outputs;
a plurality of egress nodes, each of said plurality of egress nodes having a plurality of inputs;
a plurality of crossbar switch modules, wherein a first of said plurality of crossbar switch modules is coupled to a single output from each of said plurality of ingress nodes, said first of said plurality of crossbar switch modules also being coupled to a single input from each of said plurality of egress nodes; and
a permutation engine that is operative to store a permutation connection set, each permutation connection in said permutation connection set being designed to coupled to one of said outputs from said plurality of ingress nodes to one of said inputs from said plurality of ingress nodes, said permutation connection set ensuring that each of said plurality of ingress nodes has an opportunity to connect with each of said plurality of egress nodes, said permutation engine being operative to sequentially reconfigure said first of said plurality of crossbar switch modules based on a sequence of permutation connections in said permutation connection set.

2. The switch of claim 1, wherein one of said ingress nodes is coupled to a plurality of 40 gigabit ports.

3. The switch of claim 1, wherein one of said ingress nodes is coupled to a plurality of 100 gigabit ports.

4. The switch of claim 1, wherein each of said ingress nodes is a single die in a chip.

5. The switch of claim 1, wherein each of said ingress nodes is formed using multiple chips.

6. The switch of claim 1, wherein each of said ingress nodes is formed using multiple devices.

7. The switch of claim 1, wherein said permutation engine is operative to store a plurality of permutation connection sets.

8. The switch of claim 7, wherein said permutation engine is operative to dynamically switch between said plurality of permutation connection sets based on monitoring of traffic between said M ingress nodes and said N egress nodes.

9. The switch of claim 1, wherein contention for a port of an egress node is managed through buffer credit-based signaling.

10. A method, comprising:
configuring, by a permutation engine during a first clock cycle, a crossbar switch module in accordance with a first permutation connection in a permutation connection set, said crossbar switch module being coupled to a single output from each of a plurality of ingress nodes, and being coupled to a single input from each of a plurality of egress nodes, wherein said configuration in accordance with said first permutation connection has a first defined set of cross connections between said plurality of ingress nodes and said plurality of egress nodes; and
reconfiguring, by said permutation engine during a second clock cycle, said crossbar switch module from said first defined set of cross connections to a second defined set of cross connections between said plurality of ingress nodes and said plurality of egress nodes, said second defined set of cross connections being defined using a second permutation connection in said permutation connection set.

11. The method of claim 10, further comprising sequentially repeating a reconfiguration of said crossbar switch module through a plurality of defined sets of cross connections defined by a plurality of permutation connections in said permutation connection set.

12. The method of claim 11, further comprising creating an unequal weighting of use of permutation connections in said permutation connection set.

13. The method of claim 12, wherein said creating is based on a state of one or more ingress or egress nodes.

14. The method of claim 12, further comprising skipping one or more permutation connections in said permutation connection set.

15. The method of claim 10, wherein one of said ingress nodes is coupled to a plurality of 40 gigabit or a plurality of 100 gigabit ports.

16. The method of claim 10, further comprising switching a use by said permutation engine of said permutation connection set to a second permutation connection set based on monitoring of traffic between said plurality of ingress nodes and said plurality of egress nodes.

17. The method of claim 9, wherein said first permutation connection is maintained for more than one clock cycle.

18. A method, comprising:
selecting a first predefined permutation connection from a permutation connection set having a plurality of predefined permutation connections; and
configuring, during a first clock cycle, a crossbar switch module in accordance with said selected first permutation connection, said crossbar switch module being coupled to a single output from each of a plurality of ingress nodes, and being coupled to a single input from each of a plurality of egress nodes, wherein said configuration in accordance with said first permutation connection has a first defined set of cross connections between said plurality of ingress nodes and said plurality of egress nodes;
selecting a second predefined permutation connection from said permutation connection set; and
reconfiguring, during a second clock cycle, said crossbar switch module from said first defined set of cross connections to a second defined set of cross connections between said plurality of ingress nodes and said plurality of egress nodes.

19. The method of claim 18, further comprising sequentially repeating a reconfiguration of said crossbar switch module through said plurality of predefined permutation connections.

20. The method of claim 18, wherein one of said ingress nodes is coupled to a plurality of 40 gigabit or a plurality of 100 gigabit ports.
